(19) United States
(12) Patent Application Publication
(10) Pub. No.: US 2003/0222079 A1
(43) Pub. Date: Dec. 4, 2003

(54) System for inductively heating a belt

(76) Inventors: Robert J. Lawton, Boise, ID (US); Jose Alvaro Barba Villanueva, Jalisco (MX); B. Mark Hirst, Boise, ID (US)

Correspondence Address: HEWLETT-PACKARD COMPANY, Intelectual Property Administration, P.O. Box 272400, Fort Collins, CO, 80527-2400, US

(21) Appl. No.: 10/158,983

(22) Filed: May 30, 2002

(51) Int. Cl. H05B 6/10

(52) U.S. Cl. 219/619; 219/645

(57) ABSTRACT

A system for inductively heating a belt employs a magnetic flux intensifier that serves to intensify a magnetic field through which an electrically conductive belt is driven in order to heat said belt. A workpiece such as a sheet of paper having partially dried ink (or electrophotographic toner in need of softening) can be placed in association with the belt and thereby heated in order to dry the ink (or fuse the toner).

### BACKGROUND OF THE INVENTION

1. Field of the Invention

This invention generally relates to heating electrically conductive materials by inductive heating. It is particularly concerned with heating electrically conductive sheet materials that are associated with sheets of print media such as paper in order to (1) dry ink, (2) fuse electrophotographic toner or (3) cover such sheets with protective polymer materials.

2. Prior Art

It has long been known that when a conductive material is driven through a magnetic field a current will be induced in that conductive material. These induced currents can be used to heat the material. Thus, a workpiece (e.g., a sheet of paper) that is physically associated with that heated material will be heated as well. This heating technique has been applied to many commercial and industrial processes. For example, it has been used to fix electrophotographic toners to sheets of paper. By way of a specific example of such a process, U.S. Pat. No. 5,978,641 (“the '641 patent”) teaches that an electromagnetic induction coil can be used to generate a magnetic flux system that is perpendicular to the transport direction of a toner fixing belt and that eddy-like, heat-producing, induction currents can be produced in an electrically conductive component of the toner fixing belt. A sheet of paper that is physically associated with the toner fixing belt is heated as well. The sheet of paper also carries a toner image. Thus, the toner particles that comprise the toner image are heated and, hence, softened. The softened toner particles are then mechanically pressed into the fiber of the paper.

U.S. Pat. No. 5,752,148 (“the '148 patent”) also teaches an electromagnetic induction heating device wherein an electromagnetic induction coil generates a magnetic flux perpendicular to the transport direction of toner fixing belt to produce eddy-like induction currents in a conductive member of the fixing belt and thereby heat said belt. The fixing belt, in turn, heats a sheet on the exterior side of the belt and thereby softens a toner material. A fixing structure, e.g., a pressure roller, then fixes the toner material on the heated sheet. The belt is arranged in a loop. The device further comprises a tension roller arranged such that the electromagnetic induction coil is positioned on an interior side tension roller.

### SUMMARY OF THE INVENTION

The present invention employs a magnetic flux intensifier in order to concentrate, and hence intensify, a magnetic field through which an electrically conductive belt is driven. The more concentrated magnetic field produced by use of this magnetic flux intensifier serves to induce greater electrical currents in a conductive component of the belt—relative to those electrical currents that would be induced in that same belt by less concentrated magnetic fields. The greater electrical currents resulting from the belt's passage through the more concentrated magnetic field causes relatively greater heating of the conductive material from which the belt is made. This greater heating can be used to great advantage in a variety of commercial and/or industrial processes.

For example, the magnetic flux intensifier systems of this patent disclosure are especially useful in those printing systems having a need to (1) dry a liquid printing composition such as ink (or liquid toner) on a sheet of print media such as paper, (2) fuse a particulate printing composition such as electrophotographic toner particles to a sheet of print media such as paper, (3) place a layer of a laminating material on a single side of a sheet of paper and (4) place a layer of laminating material on each side of a sheet of paper. In other applications (not involving printing operations), the hereindisclosed magnetic flux intensifier systems may be used to (1) heat a sheet of electrically conductive material in order to effect a chemical or physical change in that material, (2) affix a sheet of non-conductive material to a sheet of conductive material, (3) affix a sheet of conductive material to another sheet of the same conductive material, (4) affix a sheet of conductive material to a sheet of another kind of conductive material, (5) encase a sheet of material (non-conductive or conductive) between two distinct layers of conductive material and (6) encase a sheet of material (non-conductive or conductive) between a layer of non-conductive material and a layer of conductive material.

Thus, the systems for inductively heating a belt (or belts) and a workpiece associated with such a belt can be used in a wide variety of sheet fusing, drying and laminating operations. These fusing, drying and laminating operations can be carried out in the context of printing or in the context of an industrial process. These systems could for example be used to (1) dry inkjet printing, (2) fuse electrophotographic toner and/or apply thermal transfer overcoat materials (e.g., polymer laminates) to sheets bearing printing (e.g., sheets bearing inkjet printing, electrophotographic printing, offset printing, impact printing and the like). A preferred material for belt(s) used in the practice of this invention are those materials marketed by E.I. DuPont de Nemours and Company under their trademark Kapton®. Those Kapton® materials into which carbon particles have been incorporated are particularly preferred since such particles make the overall material electrically conductive. Such Kapton®-based materials also are characterized by their small thermal capacitance (hence, electrical energy is induced therein where it is needed) and good mechanical properties (e.g., strength, flexibility, etc.). Such Kapton®-based materials are particularly preferred in applications wherein one side of a sheet should not be touched.

By way of example of a specific industrial application (as opposed to a printing application), the hereindisclosed magnetic flux intensifier systems can be used in those heat sealing operations used to seal the bottom ends of those polymer bags commonly referred to as “trash bags”. It also should be noted in passing that applicant's use of one or more magnetic flux intensifiers in the belt heating systems of this patent disclosure also may reduce the need to employ higher power supply frequencies. Those skilled in the electrical engineering arts will appreciate that there are significant cost savings associated with the ability to use a commonly available power supply, e.g., 60 Hertz rather than go to the expense of stepping up the frequency of the commonly available power supply.

### BRIEF DESCRIPTION OF THE DRAWINGS

FIG. 1 is a perspective view of a highly generalized first embodiment of this invention wherein an electrically conductive belt is driven between a magnetic flux generating device and a magnetic flux concentrating device.

FIG. 2 is a cut-away side view of select portions of the magnetic flux generating device, belt and magnetic flux concentrating device shown in FIG. 1.

FIG. 3 is a cut-away side view of an embodiment of this invention wherein the belt carries a workpiece such as a sheet of print media (e.g., a sheet of paper).

FIG. 4 is a cut-away side view of an embodiment of this invention wherein a sheet-like workpiece is placed between two belts.

FIG. 5 is a cut-away side view of an embodiment of this invention wherein a workpiece (comprised of a sheet placed between two belts) is subjected to pressure after the workpiece leaves the magnetic flux intensifier system.

### DETAILED DESCRIPTION OF THE INVENTION

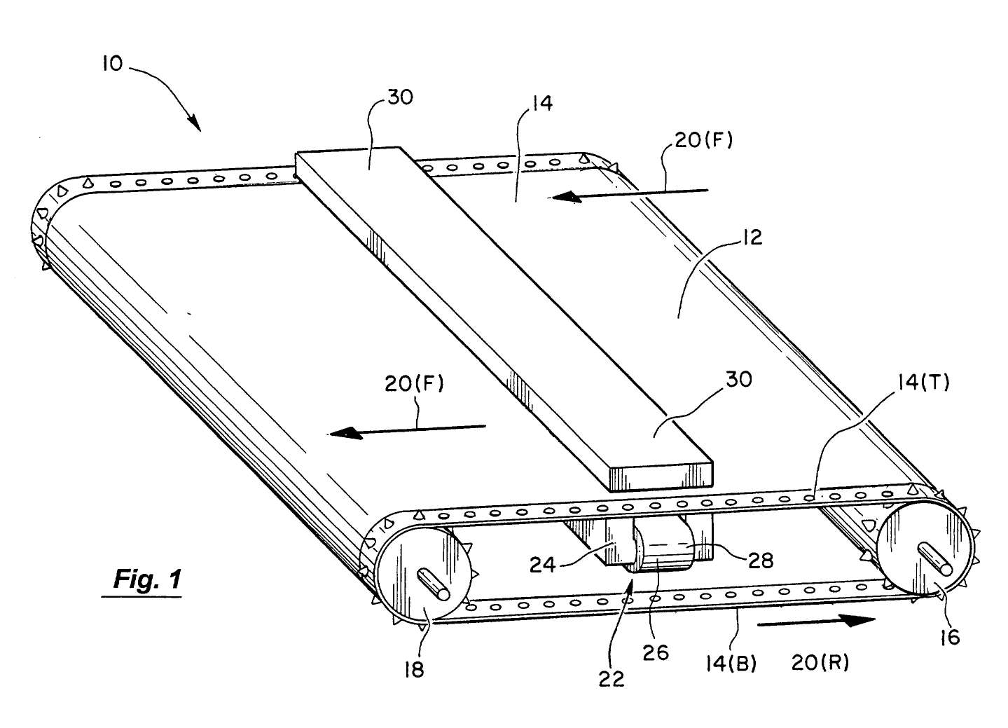

FIG. 1 is a perspective view of a system 10 for inductively heating a belt 12 according to the teachings of this patent disclosure. The belt 12 must include at least one material having an electrical resistance low enough that a current is induced in that material when it is driven through a magnetic field. The induced current serves to heat the material. The belt 12 shown in FIG. 1 is depicted as being made of a single ply material and used in the form of an endless loop 14 that is mounted on a first roller 16 and a second roller 18. Either or both of these rollers can be powered to drive the belt 12, e.g., in a forward direction 20(F) and a rearward 20(R) direction such as those suggested in FIG. 1. It should however be understood that such a belt can be made of two or more layers of material so long as at least one of those layers contains a material having an electrical resistance that is low enough that a current is induced in that material when the belt is driven through a magnetic field. It also should be understood that the belt need not be in the endless array depicted in FIG. 1. The belt shown in FIG. 1 could for example be replaced by a roll of material whose leading edge (and subsequent portions) passes through the magnetic field. Such a belt may also be replaced by successive sheets of cut material. Thus, for the purposes of this patent disclosure the term “belt” can be taken to mean any of these physical forms.

Be that as it may, the endless loop 14 type belt shown in FIG. 1 has a top portion 14(T) and a bottom portion 14(B). It also should be understood that in the practice of this invention, any belt 12 (be it a loop, a portion of a roll of feed stock material or a cut sheet) can be used to convey a workpiece such as a sheet of paper (and thereby heating that workpiece). It also should be understood that the belt itself can “be” the workpiece, or a part of a workpiece comprised of a sheet of work material (e.g., a sheet of paper) and a portion of a belt 12. Again, particularly preferred materials for such sheets are Kapton®-based materials that also contain carbon particles. Such materials can be used in applications that may reach operating temperatures up to about 400° C. (752° F.).

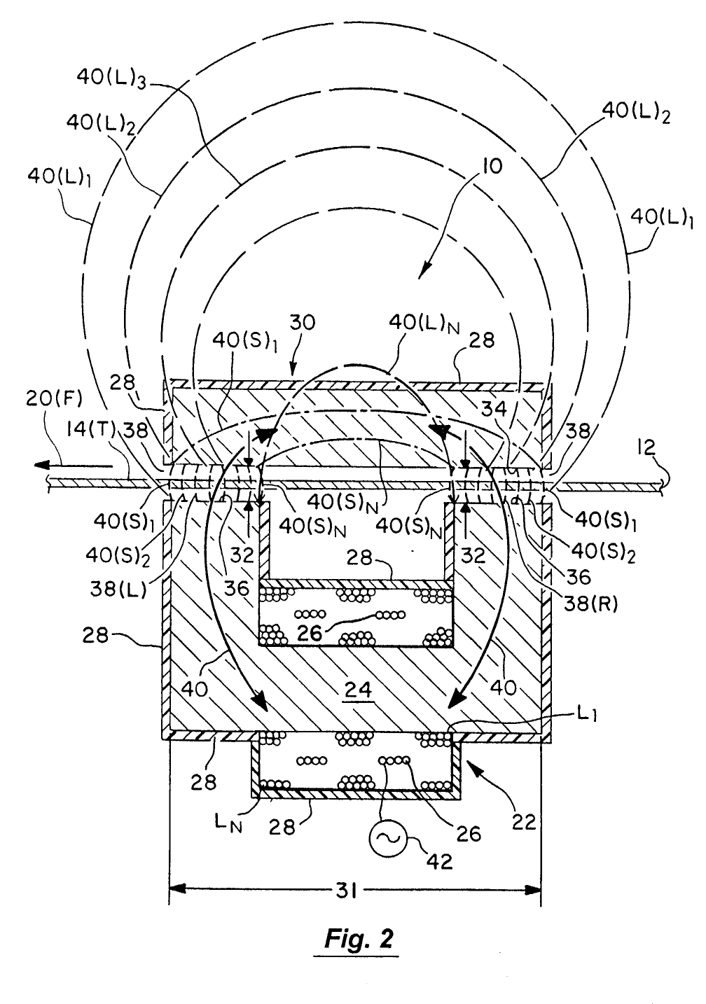

Be that as it may, a magnetic flux-generating device 22 is positioned close enough to the belt 12 that said belt falls within a magnetic field created by the magnetic flux generating device 22. In FIG. 1, for example, the magnetic flux generating device 22 is shown positioned under a portion e.g., a top portion 14(T) of the belt 12. The magnetic flux generating device 22 is generally comprised of a core 24 made of a magnetic material and a coil 26. The coil 26 is an electrically conductive wire that is wound around the core 24 in the manner shown in FIG. 2, or in ways otherwise well known to the electrical equipment manufacturing arts. In FIG. 1, the coil 26 is depicted as being covered by a layer of material 28 (e.g., a polymer) that serves as an electrical insulator. Other portions of the core 24 may be covered by a similar layer of electrical insulating material. Such electrical insulating materials generally serve to increase the electrical power use efficiency of applicant's system 10. For the purposes of this patent disclosure the efficiency of the hereindescribed system may be regarded as being “high” when most of the power (e.g., more than 60%) required by the coil 26 appears as heat in the belt 12.

FIG. 1 also shows a magnetic flux intensifier 30 positioned above the top portion 14(T) of the belt 12. The belt 12, in turn, is positioned above the magnetic flux generating device 22. As will be seen in subsequent parts of this patent disclosure, the purpose of the magnetic flux intensifier 30 is to concentrate one or more magnetic fields that are created between the intensifier 30 and the flux generating device 22 when an electrical current is applied to the coil 26 component of the flux generating device 22. Thus, the belt 12 is driven through a more concentrated or more intense magnetic field. This more concentrated magnetic field creates stronger eddy currents in the belt material. In turn these greater eddy currents heat the belt more than it would otherwise be heated if it were driven through a less intense magnetic field.

FIG. 2 is a cut-away side view of the magnetic flux generating device 22/belt 12/magnetic flux intensifier 30 system shown in FIG. 1. The magnetic flux generating device 22 has a “U” shaped core 24. Said core 24 is preferably made of a ferromagnetic material such as iron, cobalt, nickel, gadolinium, holmium, erbium and/or a variety of alloys, compounds and/or solid solutions involving transition, rare-earth and actinide elements having magnetic properties. Such magnetic materials are well known to the electrical engineering arts. A coil system 26, comprised of a number of loops L₁, L₂ . . . L_{N}, is wound about the center of the core 24. Again, for power consumption efficiency reasons, this coil system 26 is preferably covered with an electrical insulating material 28. By way of example only, such an electrical insulating material 28 could be a non-polar resin (e.g., polyethylene, polypropylene, polystyrene, etc.), a polar resin (e.g., polyvinyl chloride, polyvinyl acetate, epoxies, etc.), a ceramic material (e.g., alumina, fused silica, forsterite, etc.), a porcelain material (e.g., mica, magnesia, zirconia, etc.) and/or a crystal material (e.g., aluminum oxide, calcium carbonate, magnesium oxide, etc.). Such an insulating material 28 also can cover selected parts of the core 24 and select parts of the magnetic flux intensifier 30.

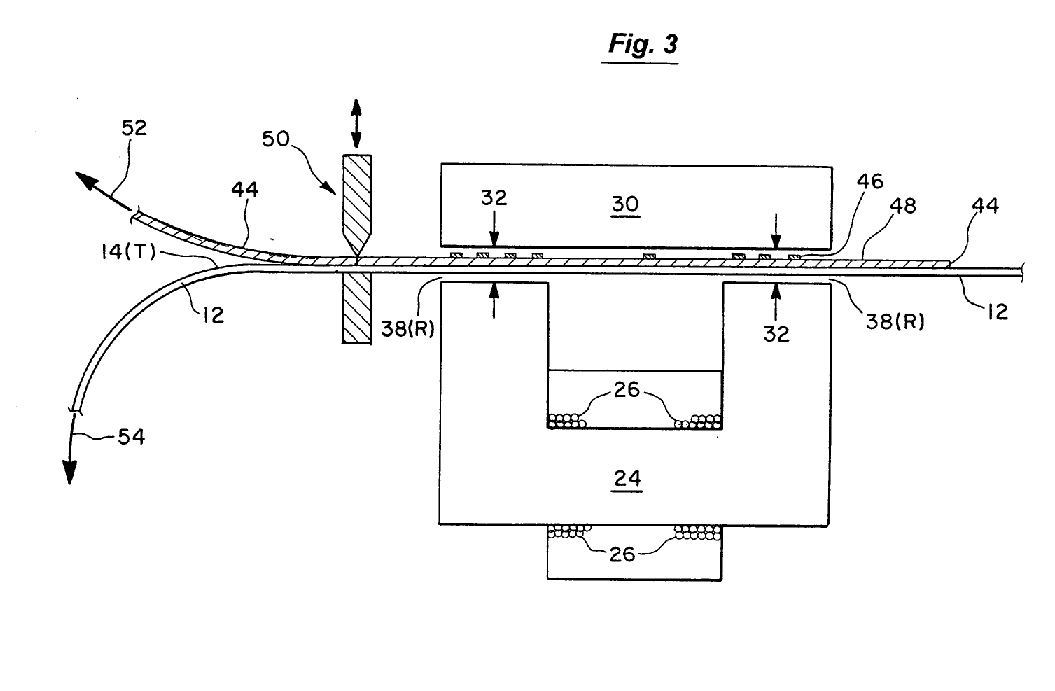

FIG. 2 shows the magnetic flux intensifier 30 positioned above the magnetic flux generating device 22 in a manner such that a gap or space 32 is defined between the intensifier 30 and the flux generating device 22. The belt 12 is shown moving through this gap 32 in a forward direction 20(F). In the more preferred embodiments of this invention, the gap 32 will be as thin or narrow as possible—consistent with free passage of the forwardly 20(F) moving belt 12 and/or any workpiece (e.g., a sheet of paper) associated with the belt 12. That is to say the belt 12 (and any workpiece associated with it) pass through the gap 32 without touching either the bottom 34 of the magnetic flux intensifier 30 or the top 36 of the core 24 of the magnetic flux generating device 22. Again, however, the gap 32 is most preferably as thin as possible. For example, when a workpiece is a sheet of paper resting on top of the belt 12, the gap 32 through which the sheet of paper and belt (see FIG. 3) are driven will preferably be from about the thickness of the belt plus about 1.5 times the thickness of the sheet of paper (e.g., the thickness of a standard 8½××11 inch, 20 lb. (75 g/m²) xerographic paper) to about the thickness of the belt plus about 5 times the thickness of the sheet of paper.

Such a belt should have, or be, a layer of material that has a low electrical resistance. Once again, applicant has found that certain Kapton®-based materials having carbon components (that provide greater electrical conductivity of the overall material) make especially good belt materials for the print media employing embodiments of this invention. Such materials have electrical resistances as low as about 10 ohms per square centimeter. It is also preferred that any material from which the belt is made have only electrical properties—and little, if any, magnetic properties. Applicants' belt materials also are preferably as thin as possible (consistent with possession of sufficient mechanical strength to withstand passage through applicant's system 10). Belt materials having thicknesses approaching that of a standard sheet of 20 lb. (75 g/m²) paper are especially preferred. Belt materials having low mass and low heat capacitance are preferably preferred since they can be heated (and cooled) more quickly. Other preferred materials for making such belts will include materials such as metals and pigfil. Belt materials that change their electrical resistance with changes in temperature may be preferred in some industrial applications.

The magnetic flux intensifier 30 also is made of a ferromagnetic material such as those from which the core 24 is made. The magnetic flux intensifier 30 can be made from the same ferromagnetic material as the core 24, or it can be made of a different ferromagnetic material. The intensifier 30 also can be covered in select regions with an insulating material 28. In one particularly preferred embodiment of this invention the core 24 and the magnetic flux intensifier 30 will have substantially the same widths 31. It might also be noted in passing that FIGS. 1 and 2 depict the magnetic flux intensifier 30 positioned above the belt 12 and the magnetic flux generating device 22 positioned below the belt. It should be appreciated, however, that the positions of the intensifier 30 and the flux generating device 22 can be interchanged.

Those skilled in the electrical engineering arts also will appreciate that when an electrical current is put on the coil system 26, a magnetic flux system or field 38 will be created in a gap 32 between the top 36 of the core 24 and the bottom 34 of the intensifier 30. Thus a magnetic force, generally indicated by arrow 40, will be transmitted from the magnetic flux generating device 22 to the magnetic flux intensifier 30 when an electrical current is applied to the coil system 26. When the current applied to the coil system 26 is an alternating current 42 the magnetic force 40 reverses direction with the cycling current. Hence, the arrow 40 depicting this reversing magnetic force is a double headed arrow.

The magnetic flux intensifier system 10 of FIG. 2 is shown having a flux system comprised of a left side magnetic field 38(L) and a right side magnetic field 38(R). The left side magnetic field 38(L) and the right side magnetic field 38(R) are shown connected by an array of lines of magnetic flux. It also should be understood that these two magnetic fields 38(L) and 38(R) are intensified or concentrated by virtue of the close proximity of the intensifier 30 to the magnetic flux generating device 22. Again the intensifier 30 should be positioned as close as possible to the magnetic flux generating device 30 consistent with free passage of the belt 12 and any workpiece associated with it. Next, it should be noted that the left side flux system 38(L) is shown as being concentrated between a left outermost line of magnetic flux 40(S)₁ and a right outermost line of flux 40(S)_{N}. The right side of the core 24/intensifier 30 system has a counterpart concentrated flux system 38(R) that is bounded by its left outermost line of magnetic flux 40(S)_{N} and its right outermost line of flux 40(S)₁. The left outermost line of magnetic flux 40(S)₁ also is shown passing from the left side of the left magnetic field 38(L), through the body of the intensifier 30, to the right side of the right magnetic field 38(R). As will be discussed in subsequent parts of this patent disclosure, the paths followed by these magnetic flux lines 40(S)₁, 40(S)₂ . . . 40(S)_{N} through the intensifier 30 are relatively direct, and hence relatively short. Moreover, the magnetic fields created by these direct lines of magnetic flux are relatively more concentrated, intense or dense relative to the circumstance discussed in the next paragraph of this patent disclosure.

Those skilled in the electrical engineering arts will appreciate that if the magnetic flux intensifier 30 were not present in the system depicted in FIG. 2, the lines of magnetic flux from the left side of the core 24 to the right side of said core would follow much more “roundabout” paths in traveling from one side of the magnetic flux generating device 22 to the other side of said device—relative to the relatively shorter paths they follow through the intensifier 30. Referring again to FIG. 2, it can be seen that the left outermost flux line that follows the short path over the gap 32 between the top 36 of the core 24 and the bottom 34 of the intensifier 30 is labeled designated 40(S)₁. The next flux line over the short path is designated 40(S)₂ and so on to 40(S)_{N}. If, however, the magnetic flux intensifier 30 were entirely absent from the system depicted in FIG. 2, the path followed by the lines of magnetic flux from the left side of the core 24 to its right side (and vice versa in the case of application of an alternating current 42 to the coil system 26) would be longer—and less concentrated.

For example, an imaginary left outermost line of flux leaving the left side of the core 24 would travel to the right side of said core over the “long” path designated 40(L)₁. A second line of flux would travel over long path 40(L)₂ and so on to the “shortest” long path 40(L)_{N}. It also should be appreciated that the magnetic field created by these relatively longer lines of flux is less concentrated (and hence less intense) than the magnetic field created through the use of the magnetic flux intensifier 30. This lower degree of magnetic flux concentration is generally depicted in FIG. 2 by the fact that there is more space between magnetic flux lines 40(L)₁ and 40(L)₂ than there is between magnetic flux lines 40(S)₁ and 40(S)₂ and so on with respect to the space between each succeeding line of flux. This all goes to say that the magnetic flux system in the gap 32 is more intense than a magnetic flux system that would exist if the magnetic flux intensifier 30 were not present in the system shown in FIG. 2. Thus, a body of electrically conductive material (e.g., belt 12) passing through the more concentrated or intense magnetic fields 38(R) and 38(L) between the core 24 and magnetic intensifier 30 will have a greater current induced it, relative passage of the same body through a less concentrated or intense magnetic field such as that depicted by flux lines 40(L)₁ to 40(L)_{N}. Consequently, the same belt material will be heated to a higher temperature. Moreover, these higher temperatures are generally confined to the regions in which the magnetic fields 38(L) and 38(R) are confined by virtue of the presence of the magnetic flux intensifier 30 in the system. This highly localized heating can be used in various industrial operations such as sealing the edges of two sheets in order to form a sack-like container, or a two ply, three ply, etc. packing material.

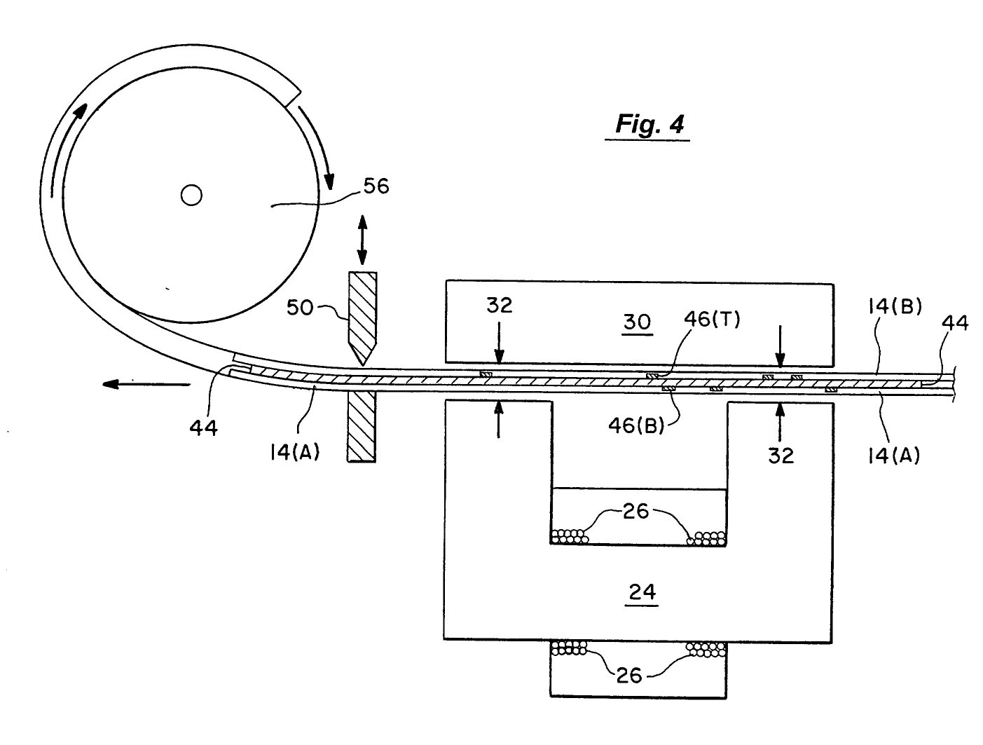

FIG. 3 depicts a cross sectional view of an embodiment of this invention wherein a sheet of work material 44 (e.g., a sheet of print media such as paper having printing in the form of ink or toner 46 on one side, e.g., its top side 48) is associated with a belt 12 as it passes through the gap 32 between the core 24 and the intensifier 30. Thus, as the belt 12 is heated by virtue of passing through the magnetic fields 38(R) and 38(L) existing in the gap 32, the workpiece 44 (e.g., a sheet of paper) is heated by conduction due to its physical association with the heated belt 14. If the workpiece 44 were a sheet of paper with ink or toner 46 on its top surface, said ink or toner 46 would be heated—and hence dried or fused. Thereafter, the layered workpiece system shown in FIG. 3 (comprised of a portion of the belt 12 and the sheet 44) can be cut into sheets by a shear system 50, or the belt 12 and the sheet 44 can be separated from each other by devices known to those skilled in this art. This general separation is depicted in FIG. 3 by direction arrows 52 and 54. In the alternative, this belt 12/sheet 44 system could be wound up on to a take-up reel such as that shown in FIG. 4—rather than being separated in the manner depicted in FIG. 3.

It might again be noted that, even though this invention is primarily concerned with drying ink on a sheet of paper, fusing electrophotographic toner to a sheet of paper and/or placing layer(s) of laminate materials (e.g., clear polymers) on a sheet of paper, said invention has other applications that are not concerned with printing, but rather are concerned with industrial manufacturing operations. Thus, the system shown in FIG. 3 can be thought of as including at least one sheet of material (either the belt 12 or the workpiece 44) having an electrical resistivity low enough that heat-creating eddy currents will be created in said material by virtue of its passage through a magnetic field in the gap 32. The workpiece 44 or the belt 12 can be any material in need of heating as part of an industrial process (e.g., curing of an electrically conductive polymeric material in order to give that material a certain hardness, opacity, color tackiness, etc.). It also should be appreciated that the belt 12 can become a component of a belt 12/workpiece 44 combination when these two components are made to adhere to each other (by virtue of their passage through the system) and cut into composite sheets by the shearing device 50.

It also should be recognized that the workpiece 44 can itself contain an electrically conductive material that is heated by a current created in the workpiece 44 by virtue of its passage through the magnetic field in the gap 32. Thus, the magnetic flux intensifier system can be used to affix a sheet of conductive workpiece 44 material to a sheet belt material (that may or may not be electrically conductive). In which case the “belt” 12 shown in FIG. 3 will be dispensed from a reel (not shown) and becomes a work product component—rather than being part of an endless array belt system such as that depicted in FIG. 1.

FIG. 4 shows another embodiment of this invention wherein a workpiece sheet 44 (such as a sheet of paper having ink or toner on one or both sides) is sandwiched between two different belts 14(A) and 14(B). By way of example only, the sheet 44 shown in FIG. 4 is depicted as having ink (or toner) 46(T) on its top side and ink or toner 46(B) on its bottom side as well. In this embodiment, at least one of the two belts is preferably made with an electrically conductive material that heats up by virtue of passing through a magnetic field between the core 24 and intensifier 30. In one particularly preferred embodiment of this invention, both belt 14(A) and belt 14(B) are independently capable of being heated by virtue of passing through the magnetic fields existing in the gap 32. Thus, such a system can provide heating to both sides of a workpiece (such as a sheet of duplex printed paper) simultaneously. After passing through the gap 32, such a workpiece system (comprised of belt 14(A), sheet 44 and belt 14(B)) can then be subjected by various other processes. For example, the workpiece system can be cut into sheets by a shearing device 50 or the workpiece system can be wound up on a take-up reel 56 and thereafter used as a product, or a component for some other industrial process.

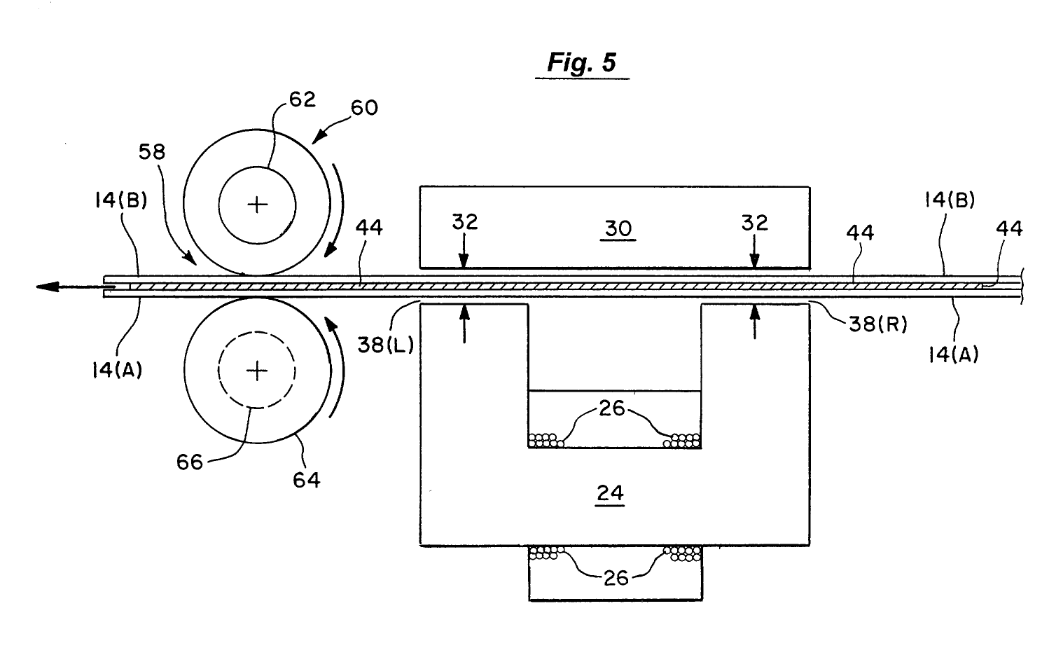

FIG. 5 depicts another particularly preferred embodiment of this invention wherein a workpiece layer system (such as the belt 14(A)/sheet 44/belt 14(B) shown in FIG. 4, or the belt 12/sheet 44 system shown in FIG. 3, or simply a belt such as that depicted in FIG. 1) is subjected to further processing that involves passage of the sheet system through a roller device 58. Such a roller device 58 can apply heat and/or pressure to any of the sheet or belt/sheet systems described in this patent disclosure. In one particularly preferred embodiment of this invention, one of the rollers e.g., roller 60 of such a roller device 58, will contain a heating element 62. It also should be appreciated that either or both of the rollers 60 and 64 can have such a heater device. Thus, a pressure roller 64 component of the roller device 58 is shown, in phantom lines, provided with a heater 66 as well. Similarly, either or both of the rollers 60 and 64 can supply the pressured rolling action that pulls a sheet or sheet/belt system through the roller 60, roller 64 interface. After clearing the roller system 58, the sheet system can be processed in various other ways. For example, such a system can be cut by shears and/or delivered to a sheet collection tray. Thereafter, a stack of such sheets can be gathered by hand or subjected to other mechanical sheet handling operations not shown, but well known to those skilled in sheet handling operations.

FIG. 5 also serves to illustrate another embodiment of this invention wherein a belt 14(B)/sheet 44/belt 14(A) system, in addition to being heated (e.g., to dry ink on a sheet of paper), also is provided with mechanical protection in the form of a top cover sheet 14(B) made of a clear plastic film or laminate material. Such a clear plastic film or laminate material gives a printed image a desirable, glossy appearance. Processes for adding such clear plastic film materials to an image bearing sheet are often referred to as “thermal transfer overlaying” processes. Consequently, FIG. 5 also depicts a highly generalized thermal transfer overlaying process wherein a clear plastic material 14(B) is fed from a supply reel on to the top surface of a sheet of print media 44. FIG. 5 also suggests that the sheet of print media 44 can be covered by a layer of clear plastic material 14(A) on its bottom side as well. Thus, a sheet of such print media 44 and the clear plastic materials 14(B) and 14(A) all simultaneously pass through the magnetic field 38 in the gap 32 in registry with each other under temperature conditions such that printed matter on the sheet 44 is simultaneously dried and permanently covered on each side with a layer of the clear plastic material. In other words, the workpiece 44 is encased between belt 14(A) and belt 14(B) by virtue of the system's passage through the gap 32 in an abutting relationship wherein heat is generated in at least one belt. Thereafter this system can be subjected to both heat and pressure in a roller system 58. Such thermal transfer overlay processes may also include a shearing device or reel system that takes up this three ply workpiece.

It also should be recognized that the workpiece 44 depicted in FIG. 5 can itself contain an electrically conductive material that is heated by a current created in that workpiece 44 by virtue of its passage through the magnetic field in the gap 32. Thus, the magnetic flux intensifier system can be used to affix a sheet of electrically conductive workpiece 44 material that is sandwiched between two sheets of other material. Thus, in another embodiment of this invention, the electrically conductive workpiece 44 material is the only material belt 14(B)/sheet 44/belt 14(A) system that is electrically conductive and hence is the material that is heated by virtue of its passage through the magnetic field in gap 32. In other embodiments, belt 14(A) and/or belt 14(B) also contain an electrically conductive (and hence heatable) material as well. Here again, in those cases where a belt material becomes a workpiece product, or a component of a workpiece product, it will be dispensed from a reel (not shown) and becomes a work product, or work product component—rather than being part of an endless array type belt system such as that depicted in FIG. 1.

Although the preceding patent disclosure sets forth a number of embodiments of the present invention, those skilled in this art will well appreciate that other arrangements or embodiments, not precisely set forth in the specifications, could be practiced under the teachings of the present invention. Therefore, the scope of this invention should only be limited by the scope of the following claims.

What is claimed is:

1. A system for inductively heating a belt, said system comprising:
a magnetic flux generating device for creating a magnetic field in a gap;
a magnetic flux intensifier positioned such that (1) a gap is defined between said intensifier and the magnetic flux generating device, (2) the magnetic field is concentrated in the gap and (3) the gap is wide enough to freely pass a sheet of material containing an electrically conductive material in which a current is induced when said sheet of material is driven through the concentrated magnetic field and thereby heating said sheet of material.

2. The system of claim 1 further comprising a belt that is driven through the concentrated magnetic field.

3. The system of claim 1 further comprising a belt and a workpiece that are driven through the concentrated magnetic field.

4. The system of claim 1 further comprising a belt and a sheet of paper that are driven through the concentrated magnetic field.

5. The system of claim 1 further comprising a first belt and a second belt that are driven through the concentrated magnetic field.

6. The system of claim 1 further comprising a first belt, a workpiece and a second belt that are driven through the concentrated magnetic field.

7. A system for inductively heating a belt, said system comprising:
a magnetic flux generating device;
a magnetic flux intensifier positioned such that a gap is defined between said intensifier and the magnetic flux generating device; and
a belt containing an electrically conductive material in which a current is induced when said belt is driven through a magnetic field in the gap and thereby heating the belt.

8. The system of claim 7 further comprising a workpiece that is physically associated with the belt.

9. The system of claim 7 further comprising a workpiece placed between the belt and the magnetic flux intensifier.

10. The system of claim 7 further comprising a sheet of paper placed between the belt and the magnetic flux intensifier.

11. The system of claim 7 wherein the belt is a workpiece.

12. The system of claim 7 wherein a portion of the belt is a component of a belt/sheet workpiece.

13. The system of claim 7 wherein the belt is in the form of an endless array.

14. The system of claim 1 further comprising a second belt that is driven through the concentrated magnetic field in association with a first belt.

15. A system for inductively heating a belt, said system comprising:
a magnetic flux generating device;
a magnetic flux intensifier positioned such that a gap is defined between said intensifier and the magnetic flux generating device;
a belt containing an electrically conductive material in which a current is induced when said belt is driven through a magnetic field in the gap and thereby heating the belt; and
a workpiece that is heated by its physical association with the belt when said belt is driven through the magnetic field in the gap.

16. The system of claim 15 wherein the workpiece is placed between the belt and the magnetic flux generating device.

17. The system of claim 15 wherein the workpiece is a sheet of paper having printing on at least one side.

18. The system of claim 15 wherein the workpiece is a sheet of paper and at least one layer of laminating material.

19. The system of claim 15 further comprising a second belt that is driven through the concentrated magnetic field in association with a first belt.

20. The system of claim 15 wherein the belt is made with a material that further comprises carbon particles.
